(19) United States
(12) Patent Application Publication
(10) Pub. No.: US 2013/0142268 A1
(43) Pub. Date: Jun. 6, 2013

(54) CONFIGURING AN UPLINK AND DOWNLINK SPLITTING PATTERN FOR DEVICE-TO-DEVICE COMMUNICATION UNDER A CELLULAR NETWORK

(71) Applicants: Chunyan Gao, Beijing (CN); haiming Wang, Beijing (CN)

(72) Inventors: Chunyan Gao, Beijing (CN); haiming Wang, Beijing (CN)

(73) Assignee: Nokia Corporation, Espoo (FI)

(21) Appl. No.: 13/816,362

(22) PCT Filed: Aug. 12, 2010
(86) PCT No.: PCT/CN2010/075924

§ 371 Date: Feb. 11, 2013

(51) Int. Cl. H04W 72/04

(52) U.S. Cl. CPC H04W 72/04
USPC 375/252; 370/329

(57) ABSTRACT

Provided are methods, apparatuses and computer program products for configuring an uplink and downlink splitting pattern for the D2D communication under the cellular network. A method comprises receiving, from a base station, mask information regarding which subframes in a frame for cellular communication may be used for device-to-device communication; and configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period. A further method comprises configuring, by a base station, an uplink and downlink splitting pattern for the device-to-device communication. With the present invention, the number of the uplink and downlink splitting patterns and complexity of its implementation will be decreased efficiently.

### FIELD OF THE INVENTION

Embodiments of the present invention generally relate to a device-to-device (D2D) communication integrated into a cellular network, such as a long-term evolution (LIE) network specified by the 3rd Generation Partnership Project (3GPP). More particularly, embodiments of the present invention relate to methods, apparatuses and computer program products for configuring an uplink and downlink splitting pattern for the D2D communication under the cellular network.

### BACKGROUND OF THE INVENTION

Various abbreviations that appear in the specification and/or in the drawing figures are defined as below:

LTE R8 LTE Release 8

BS Base Station

RRM Radio Resource Management

UE User Equipment

TDD Time Division Duplexing

FDD Frequency Division Duplexing

ACK Acknowledgment

NACK Non-Acknowledgment

HARQ Hybrid Automatic Repeat Request

SRS Sounding Reference Signal

UL Uplink

DL Downlink

RB Resource Block

OFDM Orthogonal Frequency Division Multiplexing

RACH Random Access Channel

PDCCH Physical Downlink Control Channel

PDSCH Physical Downlink Shared Channel

DwPTS Downlink Pilot Time Slot

UpPTS Uplink Pilot Time Slot

GP Guard Period

QoS Quality of Service

TTI Transmission Timing Interval

BCH Broadcast Channel

SCH Synchronization Channel

CQI Channel Quality Indicator

Recently, the D2D communication has become a hot topic in the wireless communication techniques because it can improve local area coverage and resource efficiency, save transmit power of the UE and BS, facilitate offloading from the cellular network, and provide the potential new types of services to a UE. There are two types of D2D operation: one is BS-controlled in-band D2D and the other is autonomous D2D. As compared to the autonomous D2D, the BS-controlled in-band D2D may achieve higher QoS, better resource efficiency, and easier control by operators. The BS-controlled in-band D2D can be implemented in both FDD and TDD cellular networks, preferably in the UL resource (e.g., FDD UL bands or TDD UL subframes). In case there is little UL resource for the D2D communication, the DL resource should also be taken into account. For instance, by making use of the DL resource, the resource configuration for the D2D communication under the TDD cellular network has three scenarios as below:

Scenario 1: D2D UEs only communicate in the UL subframes of the TDD cellular network;

Scenario 2: D2D UEs communicate in the GP part of a special subframe and the UL subframes of the TDD cellular network; and

Scenario 3: D2D UEs communicate in the DL subframes, the GP part of the special subframe and UL subframes of the TDD cellular network.

As illustrated above, three scenarios are now available for the D2D communication under the cellular network. Each scenario allocates different number of subframes per frame (generally 10 ms) for the D2D communication. Because the D2D communication may adopt the TDD mode, the available subframes are further divided into D2D UL and DL subframes. In the present invention, the D2D UL refers to an UL from a slave device to a master device with which the slave device communicates in the D2D communication and the D2D DL refers to a DL from the master device to the slave device. During the D2D communication, the master device may have certain of the same functions as the BS. With different number of the subframes being available, the number of possible DL and UL splitting patterns also vary.

For example, assuming the TDD cellular network adopts the TDD frame configuration 1 (for more information regarding the TDD frame configuration, see technical specification TS 36.211, which is incorporated herein by reference in its entirety), which has four UL TTIs (i.e., four UL subframes) per frame, if the scenario 1 only using the UL subframes is applied, then only four subframes are available for the D2D communication and they can be further divided based upon the ratios of the number of the UL and DL subframes, e.g., ratios 3/1, 2/2 or 1/3, wherein 3/1 means three UL subframes and one DL subframe for the D2D communication. For the same cellular configuration, if scenario 3 using DL+GP+UL subframes is applied and the subframes 1, 2, 3, 4, 6, 7, 8, and 9 are available for the D2D communication, then there are enormous ways to divide them because the ratios of the number of the UL and DL subframes (e.g., 7/1, 2/6, 3/5, 1/7, and etc) are multitudinous.

Furthermore, it should be noted that for each of the ratios, it can be achieved by using more than one UL and DL splitting pattern. For instance, if the ratio is 1/2 (meaning one UL subframe and two DL subframes), then it can be realized by (UL, DL, DL), (DL, UL, DL), or (DL, DL, UL), i.e., total of three UL and DL splitting patterns. For purpose of better understanding, FIG. 1 illustrates that the cellular network adopts the TDD frame configuration 3 and only UL resource is allowed to be used for the D2D communication. As illustrated in FIG. 1, each sub-box represents one subframe and contains characters “D,” “S,” or “U,” representative of the DL subframe, special subframe and UL subframe, respectively. It can be seen that the third to fifth subframes in each ten subframes are allowed to be used for the D2D communication. When the ratio of the number of the UL and DL is 2/1 or 1/2, there are six kinds of possible UL and DL splitting patterns, as illustrated over six arrow lines. Without forbidding some UL and DL splitting patterns from being applied for the D2D communication, the number of the possible UL and DL splitting patterns increases exponentially with the increasing number of available subframes for the D2D communication.

However, the more the number of possible UL and DL splitting patterns, the more the complicated of UE implementation and signaling design. In addition, some UL and DL splitting patterns require multiple GPs for switching the DLs and ULs and thus reduce the resource efficiency. Therefore, the existence of too many possible UL and DL splitting patterns may cause inconvenience and inefficiency for the D2D communication under the cellular network.

### SUMMARY OF THE INVENTION

In view of the foregoing problems in the UL and DL splitting patterns, there is a need in the art to provide methods and apparatuses for configuring the UL and DL splitting pattern in a particular manner so that only UL and DL splitting patterns that are in conformity with a rule may be applied to the D2D communication.

One embodiment of the present invention provides a method. The method comprises receiving, from a base station, mask information regarding which subframes in a frame for cellular communication may be used for device-to-device communication. The method also comprises configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

In one embodiment, the method may further comprise subsequent to the configuring, reconfiguring the uplink and downlink splitting pattern. In another embodiment, the method may further comprise receiving, from the base station, position information regarding the start position of the subframe configuration period. In a further embodiment, the method may further comprise receiving, from the base station, value information regarding values for the integers X and N.

In one embodiment, the method may further comprise signaling the uplink and downlink splitting pattern to a slave device for the device-to-device communication. In another embodiment, based upon the UL and DL splitting pattern, a guard period of a special subframe in the frame for the cellular communication may be used for one of:

a reserved or fixed downlink subframe for sending the uplink and downlink splitting pattern to be used for the device-to-device communication;

sending preamble to aid interference measurement;

a reserved or fixed downlink subframe for sending an uplink grant from a master device to a slave device with which the master device communicates in the device-to-device communication;

a communication channel for the master device or the slave device for sending feedback to the base station;

a communication channel for the device-to-device communication; and

an uplink subframe in the device-to-device communication for the master device to monitor signaling information sent by the base station.

In another embodiment, the method may further comprise configuring the one special downlink subframe in the uplink and downlink splitting pattern as one of:

a shorted downlink subframe consisting of fourteen orthogonal frequency division multiplexing symbols and a last symbol being used in switching uplink and downlink of the device-to-device communication;

a shorted downlink subframe consisting of fourteen orthogonal frequency division multiplexing symbols in which fourth to thirteenth symbols are used in the device-to-device communication and remaining symbols are used in monitoring a packet dedicated control channel from a base station and switching the uplink and downlink of the device-to-device communication; and

a shorted downlink subframe only using a guard period and uplink pilot time slot parts of a special downlink subframe in cellular communication.

In one embodiment, the configuring the uplink and downlink splitting pattern is performed in a dynamic manner. The method may further comprise one of:

predefining one uplink and one downlink subframe per subframe configuration period for sending an acknowledgement or a negative acknowledgement feedback, a channel quality indicator report, uplink scheduling, preamble, and the uplink and downlink splitting pattern;

predefining one downlink subframe per subframe configuration period to send uplink scheduling and the uplink and downlink splitting pattern for the next subframe configuration period and sending an acknowledgement or a negative acknowledgement feedback for the downlink transmission at the earliest possible uplink subframe; and

sending, at the earliest possible uplink and downlink subframe, an acknowledgement or a negative acknowledgement for scheduled downlink and uplink subframes and uplink scheduling.

In another embodiment, the method may further comprise performing the device-to-device communication based upon the uplink and downlink splitting pattern.

Another embodiment of the present invention provides a method. The method comprises determining, mask information regarding which subframes in a frame for cellular communication may be used for device-to-device communication. The method may further comprise configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

In one embodiment, the method may further comprise signaling the uplink and downlink splitting pattern to a master device for the device-to-device communication. In another embodiment, the method may further comprise determining the start position of the subframe configuration period and values of X and N.

In a further embodiment, based upon the uplink and downlink splitting pattern, a guard period of a special subframe in the frame for the cellular communication may be used for one of:

a reserved or fixed downlink subframe for sending the uplink and downlink splitting pattern to be used for the device-to-device communication;

sending preamble to aid interference measurement;

a reserved or fixed downlink subframe for sending an uplink grant from a master device to a slave device with which the master device communicates in the device-to-device communication;

a communication channel for the master device or the slave device to send feedback to the base station;

a communication channel for the device-to-device communication; and

an uplink subframe in the device-to-device communication for the master device to monitor signaling information sent by the base station.

In an additional embodiment, the method may further comprise configuring the one special downlink subframe in the uplink and downlink splitting pattern as one of:

a shorted downlink subframe consisting of fourteen orthogonal frequency division multiplexing symbols and last symbol being used in switching uplink and downlink of the device-to-device communication;

a shorted downlink subframe consisting of fourteen orthogonal frequency division multiplexing symbols in which fourth to thirteenth symbols are used in the device-to-device communication and remaining symbols are used in monitoring a packet dedicated control channel from a base station and switching the uplink and downlink of the device-to-device communication; and

a shorted downlink subframe only using a guard period and uplink pilot time slot parts of a special downlink subframe in cellular communication.

In one embodiment, the configuring the uplink and downlink splitting pattern is performed in a dynamic manner. The method may further comprise one of:

predefining one uplink and one downlink subframe per subframe configuration period for sending an acknowledgement or a negative acknowledgement feedback, a channel quality indicator report, uplink scheduling, preamble, and the uplink and downlink splitting pattern;

predefining one downlink subframe per subframe configuration period to send uplink scheduling and the uplink and downlink splitting pattern for the next subframe configuration period and sending an acknowledgement or a negative acknowledgement feedback for the downlink transmission at the earliest possible uplink subframe; and

sending, at the earliest possible uplink and downlink subframe, an acknowledgement or a negative acknowledgement for scheduled downlink and uplink subframes and uplink scheduling.

One embodiment of the present invention provides an apparatus. The apparatus comprises means for receiving, from a base station, mask information regarding which subframes in a frame for cellular communication may be used for device-to-device communication. The apparatus further comprises means for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period. In one embodiment, the apparatus comprises a device-to-device communication enabled mobile station.

Another embodiment of the present invention provides an apparatus. The apparatus comprises means for determining, mask information regarding which subframes in a frame for cellular communication may be used for device-to-device communication. The apparatus further comprises means for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period. In one embodiment, the apparatus comprises a base station.

An additional embodiment of the present invention provides an apparatus. The apparatus comprises at least one processor, and at least one memory including computer program code, the at least one memory and the computer program code configured to, with the at least one processor, cause the apparatus to at least perform receiving, from a base station, mask information regarding which subframes in a frame for cellular communication may be used for device-to-device communication and configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period. In one embodiment, the apparatus comprises a device-to-device communication enabled mobile station.

Another embodiment of the present invention provides an apparatus. The apparatus comprises at least one processor, and at least one memory including compute program code, the at least one memory and the computer program code configured to, with the at least one processor, cause the apparatus to at least perform determining, mask information regarding which subframes in a frame for cellular communication may be used for device-to-device communication; and configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period. In one embodiment, the apparatus comprises a base station.

One embodiment of the present invention provides a computer program product. The computer program product comprises at least one computer readable storage medium having a computer readable program code portion stored thereon. The computer readable program code portion comprises program code instructions for receiving, from a base station, mask information regarding which subframes in a frame for cellular communication may be used for device-to-device communication. The computer readable program code portion further comprises program code instructions for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

Another embodiment of the present invention provides a computer program product. The computer program product comprises at least one computer readable storage medium having a computer readable program code portion stored thereon. The computer readable program code portion comprises program code instructions for determining, mask information regarding which subframes in a frame for cellular communication may be used for device-to-device communication. The computer readable program code portion further comprises program code instructions for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

With certain embodiments of the present invention, LTE R8 TDD frame configurations can be acquired by predefining some specific values for N and X without introducing any additional GP for switching. Thus, less influence may be introduced to prior art specifications and tests. Likewise, flexible ratios of the number of UL and DL subframes for the D2D communication can be achieved and the problem of allowing too much implementation for the same ratio of the number of UL and DL subframes can be solved and thereby complexity of the implementation can be reduced.

Furthermore, it is guaranteed that there are some preserved DL and UL subframes for the D2D communication in each subframe configuration period and such subframes may be used for sending DL/UL controlling information, which is helpful in case of a dynamic DL and UL splitting pattern. By adjusting the mask information and the start position of the subframe configuration period appropriately, cellular DL subframes may be used as D2D UL subframes, enabling a master device in the D2D communication to monitor signaling information that is sent from the BS in these subframes.

Other features and advantages of the embodiments of the present invention will also be understood from the following description of specific embodiments when read in conjunction with the accompanying drawings, which illustrate, by way of example, the principles of embodiments of the invention.

### BRIEF DESCRIPTION OF THE DRAWINGS

The embodiments of the invention are presented in the sense of examples and their advantages are explained in greater detail below with reference to the accompanying drawings, in which:

FIG. 1 exemplarily illustrates a diagram of a plurality of possible UL and DL splitting patterns for the D2D communication under the cellular frame configuration 3;

FIG. 2 is a flow chart illustrating a method for configuring the UL and DL splitting pattern for the D2D communication under the cellular frame configuration according to an embodiment of the present invention;

FIG. 3 is a flow chart illustrating another method for configuring the UL and DL splitting pattern for the D2D communication under the cellular frame configuration according to an embodiment of the present invention;

FIG. 4 exemplarily illustrates diagrams of three UL and DL splitting patterns for the D2D communication under the cellular frame configurations, in which the subframe configuration periods start from the second, third and fifth subframe,

respectively;

FIG. 5 exemplarily illustrates a diagram of three kinds of UL and DL splitting pattern for the D2D communication under the cellular frame configuration, in which the first two kinds of UL and DL splitting patterns are configured in a semi-static manner and the third kind of UL and DL splitting pattern is configured in a dynamic manner; and

FIG. 6 exemplarily illustrates three different options for determining the HARQ and scheduling for the UL and DL splitting pattern configured in a dynamic manner, as illustrated in FIG. 5.

### DETAILED DESCRIPTION OF EMBODIMENTS

Embodiments of the present invention will be described in detail as below.

In one embodiment of the present invention, the BS sends mask information to a master device in the D2D communication via applicable signaling, wherein the mask information indicates which subframes in the frame for the cellular communication may be used for the D2D communication. The master device configures, based upon the received mask information, an UL and DL splitting pattern for the D2D communication. The configured UL and DL splitting pattern includes one special DL subframe, X UL subframes immediately following the special DL subframe, and (N−1−X) DL subframes immediately following the X UL subframes, wherein integer N is a subframe configuration period and integer X is the number of UL subframes included in the subframe configuration period. The values of X and N can be determined and signaled by the BS to the master device or configured by the master device itself based upon traffic throughput. The start position of the subframe configuration period can also be determined by the BS. In another embodiment of the present invention, the BS is capable of solely completing above configuration and transmitting the resulting UL and DL splitting pattern to the master device or slave device that is involved in the D2D communication.

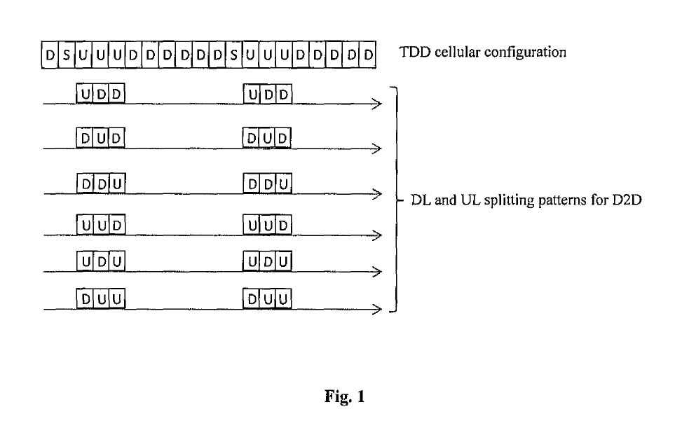

FIG. 1 has been described previously. It exemplarily illustrates a diagram of a plurality of possible UL and DL splitting patterns for the D2D communication under the cellular frame configuration 3.

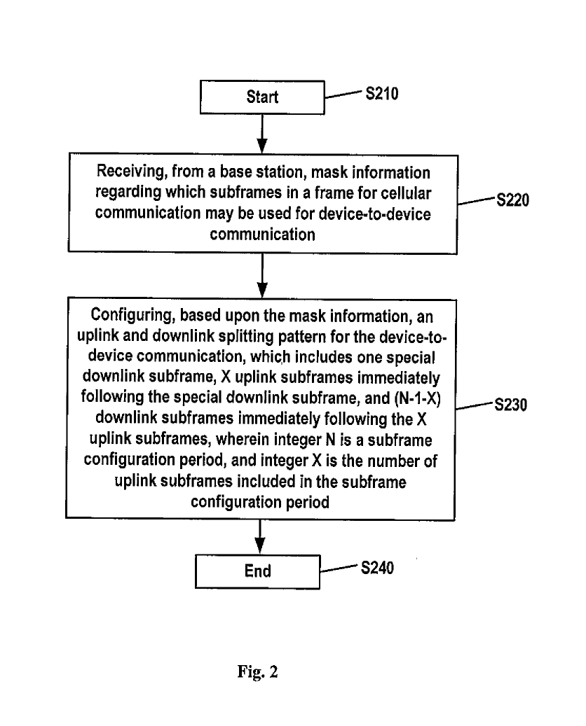

FIG. 2 is a flow chart illustrating a method for configuring the UL and DL splitting pattern for the D2D communication under the cellular frame configuration according to an embodiment of the present invention. As illustrated in FIG. 2, the method 200 begins at step S210 and receives, at step S220, from a base station, mask information regarding which subframes in a frame for cellular communication may be used for the D2D communication. The operations regarding the step S220 will be described in greater detail as below.

First, although the figures of the present application do not show the mask information directly, it can be understood that such mask information (also referred to as “permission mask”) may be some identifiers or simply binary bits 0 and 1 carried by the signaling, wherein 1 may indicate to the master device that the cellular subframe is allowed to be used for the D2D communication and 0 may indicate to the master device that the cellular subframe is not allowed to be used for the D2D communication, and vice versa. By forming an appropriate permission mask, all the three scenarios for the D2D resource configuration as mentioned previously may be supported.

Further, under the current LTE TDD cellular frame configuration scheme, one frame generally consists of ten subframes, renumbered from 0 to 9. BCH and SCH signaling information is generally in subframes 0, 1, 5, and 6. Due to the nature of TDD (i.e., transmitting and receiving cannot occur simultaneously), the D2D communication occurring in the above subframes may encounter a problem of failing to receive the broadcast and synchronization information sent from the BS. However, in case that only the master device in the D2D communication needs to monitor the BCH and SCH, then the subframes 0, 1, 5, and 6 may still be used for the transmission from the slave device in the D2D communication. In other words, the subframes 0, 1, 5, and 6 carrying signaling information may be used for the D2D UL. Thus, the permission mask may cover the foregoing subframes such that they may be used for the D2D communication, regardless of what kind of information they may carry.

In particular, if the permission mask allows subframes 0 and 5 to be used for the D2D communication, then both subframes may be used by the slave device for transmission. However, the resource allocated for the D2D communication should not occupy the resource reserved for monitoring the BCH and SCH, e.g., the central six RB in the corresponding OFDM symbols. In addition, if the subframes 1 and 6 have been configured as the special subframes in the cellular communication and the permission mask allows both subframes to be used for the D2D communication, then due to the fact that the control or broadcast signaling only exists in DwPTS part of the subframe and the GP and UpPTS parts thereof may still be used for the D2D communication.

With respect to the GP part as mentioned above, in one embodiment, it may be a reserved or fixed DL subframe for sending the UL and DL splitting pattern by the master device. In another embodiment, the GP part may be used for sending preamble to aid interference measurement. In a further embodiment, the GP part may be a reserved or fixed DL subframe for sending an UL grant from the master device to the slave device. In one embodiment, the GP part may be a communication channel over which the D2D UE (the master or slave device) sends the feedback to the BS. In this case, the GP part is not used for the D2D communication but reserved for the cellular communication. In an additional embodiment, the GP part may be a communication channel for the D2D communication, e.g., sending the D2D communication control, SRS, user data, or serving as RACH. In another embodiment, the GP part may serve as an UL subframe in the D2D communication which allows the master device to monitor signaling information sent by the BS.

The foregoing has described in detail the operations regarding the mask information and its application in TDD cellular frame configurations involved in the step S220 of the method 200.

Now returning to FIG. 2, at step S230, the method 200 configures, based upon the mask information, an UL and DL splitting pattern for the D2D communication, which includes one special DL subframe, X UL subframes immediately following the special DL subframe, and (N−1−X) DL subframes immediately following the X UL subframes, wherein integer N is a subframe configuration period, and integer X is the number of UL subframes included in the subframe configuration period.

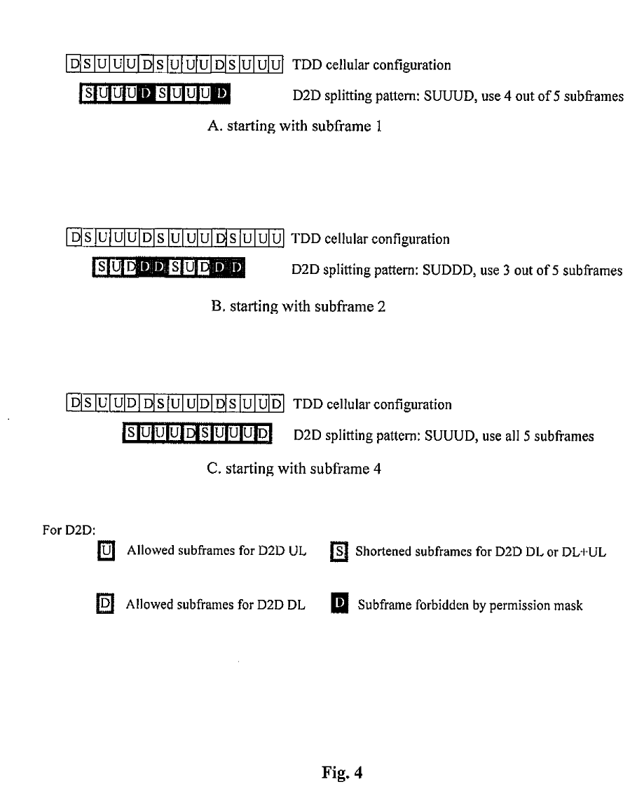

Hereinafter, the operations regarding the step S230 will be described in greater detail as below in connection with FIGS. 4, 5, and 6.

Firstly, in one embodiment, the BS may determine, at a higher layer of communication, values for the integers X and N based upon the traffic estimation for services required by D2D UEs. Alternatively, the values for the integers X and N can be determined or configured by the master device solely. Additionally, the values for the integers X and N may be configured by the BS at first and then reconfigured by the master device according to the requirements of the D2D communication. The configured or reconfigured UL and DL splitting pattern can be sent to the master device or the slave device in any appropriate D2D DL subframe.

By way of configuring some appropriate values, the possible UL and DL splitting patterns may be limited to LTE TDD R8 frame configuration schemes. For example, by letting N=5 and X=3, it may result in the UL and DL splitting pattern: S U U U D. Due to periodicity, upon shifting one subframe, it may result in the UL and DL splitting pattern: D S U U U, which exactly corresponds to the LTE R8 TDD configuration 0. Likewise, by letting N=10 and X=2, it may result in the UL and DL splitting pattern: S U U D D D D D D D, which exactly corresponds to the LTE R8 TDD configuration 4.

In view of the fact that the D2D communication belongs to local area communication with low power and may have incompatible subframe structures with the other TDD system, in one embodiment, position information regarding the start position of the subframe configuration period may be received from the BS. That is, the start position of the subframe configuration period may be determined or configured by the BS.

With respect to the start position, FIG. 4 exemplarily shows three cases, A, B and C, in which the subframe configuration period is constant (5 subframes) and starts with the cellular subframes 1, 2 and 4, respectively. The following will describe the three cases in detail.

As illustrated in case A of FIG. 4, by making use of the permission mask, the subframes (except the sixth and the eleventh subframes) in the TDD cellular configuration are allowed to be used for the D2D communication. By letting N=5 and X=3, it may result in the UL and DL splitting pattern: S U U U D. Because the last D subframe in each subframe configuration period exactly corresponds to the forbidden subframe (i.e., the sixth or eleventh subframe, forbidden by the permission mask) in the cellular configuration, the D2D communication can only be implemented on the first four subframes in each subframe configuration period. In this case, the special DL subframe in the D2D communication may be shortened D2D DL subframe or DL+UL subframe based upon certain symbols.

With respect to the shortened DL subframe, in one embodiment, it may consist of fourteen OFDM symbols and the last symbol is used for switching UL and DL of the D2D communication. In a further embodiment, it may consist of fourteen OFDM symbols in which the fourth to thirteenth symbols are used in the D2D communication and the remaining symbols are used in monitoring PDCCH from Node 13 and switching UL and DL of the D2D communication. In an additional embodiment, it may only use a GP and UpPTS parts of a special subframe in the cellular communication.

As illustrated in case B of FIG. 4, the subframe configuration period starts with the cellular subframe 2. Although the permission mask only allows every three successive cellular UL subframes to be used for the D2D communication, by letting X=1, the resulting UL and DL splitting pattern (S U D D D) still ensures one DL subframe may be used for sending the D2D DL control information. Of course, the last two DL subframes in the resulting UL and DL splitting pattern are invalid and cannot be used for the D2D communication.

As illustrated in case C of FIG. 4, the subframe configuration period starts with the cellular subframe 4 and the cellular subframe 0 (in the next period as illustrated) or 5 are always allowed to be used for the D2D UL communication. This enables the master device to receive (or monitor) the signaling information sent from the BS by this subframe.

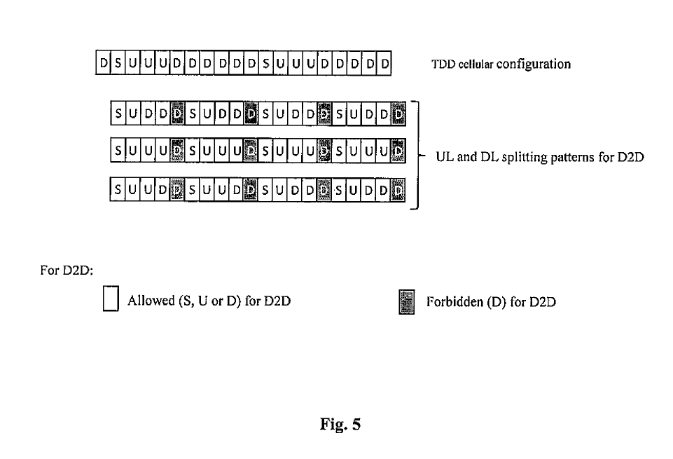

The configuring the UL and DL splitting pattern at step S230 of the method 200 can be carried out in a semi-static or dynamic manner, which will be described below in connection with FIG. 5.

FIG. 5 exemplarily illustrates a diagram of three kinds of UL and DL splitting patterns for the D2D communication under the cellular frame configuration, in which the first two kinds of UL and DL splitting patterns have been configured in a semi-static manner and the third kind of UL and DL splitting pattern has been configured in a dynamic manner. Herein, the term “semi-static” refers to a state in which no change occurs in the UL and DL splitting pattern during a relative long time while the term “dynamic” refers to another state in which frequent changes (or configuring) occur in the UL and DL splitting pattern during a relative short time. For example, during the exemplary time period, the first two kinds of UL and DL splitting patterns remain unchanged, i.e., S U D D D and S U U U D. However, the third kind of UL and DL splitting pattern has changed twice in the same time period as above, i.e., S U U D D and S U D D D.

With respect to the UL and DL splitting pattern configured in a semi-static manner, the HARQ timing for the D2D communication may be predefined based upon the criteria of the LTE R8 TDD. Because only the cellular subframes covered (or allowed) by the permission mask may be used for the D2D communication, the delay of the HARQ timing may be different from that of LTE R8 TDD.

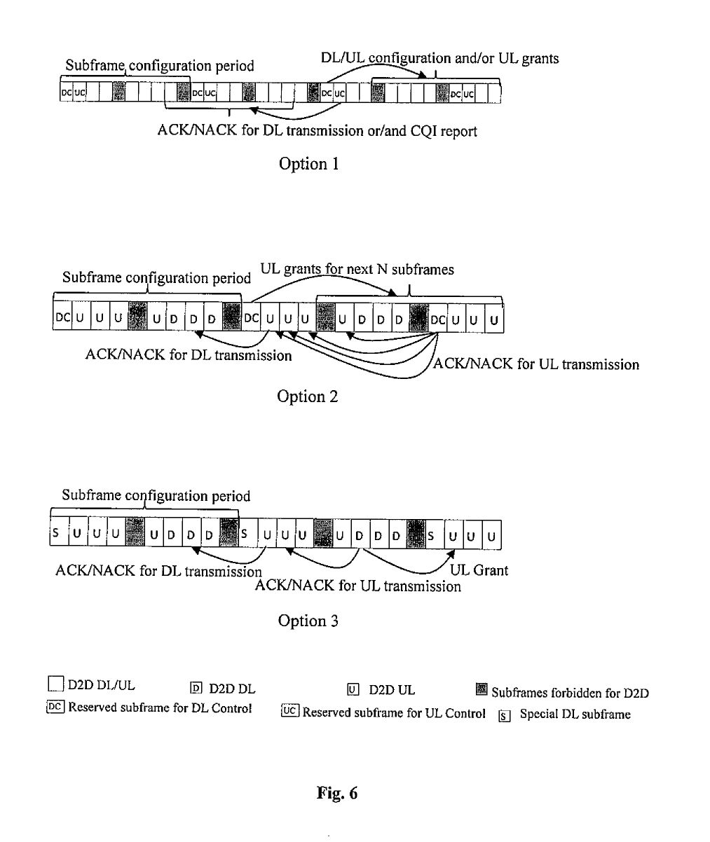

However, with respect to the UL and DL splitting pattern configured in a dynamic manner, it is difficult to achieve the HARQ because of variable patterns. To determine the HARQ timing, three options are presented, which will be described below in connection with FIG. 6.

FIG. 6 exemplarily illustrates three different options for determining the HARQ and scheduling for the UL and DL splitting pattern configured in a dynamic manner.

In option 1, one UL and one DL subframe per subframe configuration period are predefined for sending an ACK or NACK feedback, channel quality indicator report, UL scheduling, preamble, and the UL and DL splitting pattern. As illustrated in option 1 and indicated by arrows, one UC subframe has been preset to send ACK/NACK for the D2D DL transmission and/or CQI report; one DC subframe has been preset to send the UL and DL splitting pattern and/or UL grants for the forthcoming successive subframes. By predefining dedicated subframes for HARQ independent of the TDD cellular configuration, option 1 is easy to implement.

In option 2, one DL subframe per subframe configuration period is predefined for sending the UL scheduling and UL and DL splitting pattern for the next subframe configuration period and an ACK or NACK feedback for the DL transmission (e.g., PDSCH) is sent at the earliest UL subframe based upon the dynamic UL and DL splitting pattern. The GP part in the special subframe of the cellular communication may act as such DL subframe. Herein, the earliest UL subframe does not refer to the first UL in the UL and DL splitting pattern. It may be some other UL subframe in view of the time for processing of DL transmission. As illustrated in option 2 and indicated by arrows, one DC subframe is reserved for sending UL grants for the next N subframes; another DC subframe is predefined for sending ACK or NACK for the previous several UL transmission; one earliest UL subframe which meets the requirement of the processing delay is predefined, based upon the dynamic UL and DL splitting pattern, in each subframe configuration period for sending ACK or NACK for DL transmission. The option 2 is helpful in reducing the DL HARQ delay while keeping UL scheduling timing unchanged.

In option 3, an ACK or NACK for scheduled DL and UL subframes is sent at the one earliest possible UL and DL subframe. In particular, ACK/NACK for PDSCH/PUSCH is sent in the earliest UL/DL subframe based upon the dynamic UL and DL splitting pattern. As illustrated in option 3 and indicated by arrows, one earliest UL subframe which meets the requirement of the processing delay is used for sending ACK or NACK for DL transmission. One earliest DL subframe is used for sending ACK or NACK for UL transmission and UL grant. The option 3 does not need to reserve DL/UL for feedback in advance. The feedback will be sent in the earliest possible UL/DL subframe.

The foregoing has described, in connection with FIGS. 4, 5, and 6, the operations regarding the determination of the values for integers X and N, selection of the start position of the subframe configuration period, the use of the special subframe and how to achieve HARQ in the dynamic UL and DL splitting pattern or the like involved in the step S230 of the method 200.

Returning to FIG. 2, the method 200 ends at step S240.

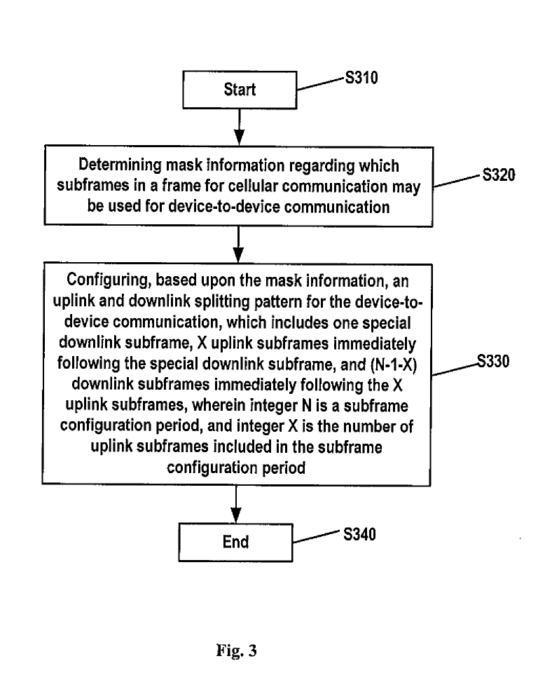

FIG. 3 is a flow chart illustrating another method for configuring the UL and DL splitting pattern for the D2D communication under the cellular frame configuration according to an embodiment of the present invention.

As illustrated in FIG. 3, the method 300 begins at step S310 and determines at step S320 mask information regarding which subframes in a frame for cellular communication may be used for the D2D communication. At S330, the method 300 configures, based upon the mask information, an UL and DL splitting pattern for the D2D communication, which includes one special DL subframe, X UL subframes immediately following the special DL subframe, and (N−1−X) DL subframes immediately following the X UL subframes, wherein integer N is a subframe configuration period, and integer X is the number of UL subframes included in the subframe configuration period. Next, the method 300 ends at step S340.

Because the operations with respect to the mask information, the values of integer N and X, the start position of the subframe configuration period, the special subframe, dynamic configuration and its HARQ implementation, are the same as previously described in the method 200 in connection with FIGS. 4, 5, and 6, their description is thus omitted herein for conciseness.

The exemplary embodiments as described above are directed to a LTE R8 TDD communications network. However, the exemplary embodiments are not limited to this illustrative, non-limiting example application and the use of the exemplary embodiments to provide rules for the advantageous configuring the UL and DL splitting pattern in a FDD communication network is envisioned as part of the present invention and within the scope of any claims attached.

In addition, exemplary embodiments of the present invention have been described above with reference to block diagrams and flowchart illustrations of methods, apparatuses (i.e., systems). It should be understood that each block of the block diagrams and flowchart illustrations, and combinations of blocks in the block diagrams and flowchart illustrations, respectively, can be implemented in various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method, comprising:
receiving, from a base station, mask information regarding which subframes in a frame for cellular communication may be used for device-to-device communication; and
configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

2. A method as recited in claim 1, further comprising, subsequent to the configuring, reconfiguring the uplink and downlink splitting pattern.

3. A method as recited in claim 1, further comprising receiving, from the base station, position information regarding the start position of the subframe configuration period.

4. A method as recited in claim 1, further comprising receiving, from the base station, value information regarding values for the integers X and N.

5. A method as recited in claim 1, further comprising signaling the uplink and downlink splitting pattern to a slave device for the device-to-device communication.

6. A method as recited in claim 1, wherein based upon the uplink and downlink splitting pattern, a guard period of a special subframe in the frame for the cellular communication may be used for one of:
a reserved or fixed downlink subframe for sending the uplink and downlink splitting pattern to be used for the device-to-device communication;
sending preamble to aid interference measurement;
a reserved or fixed downlink subframe for sending an uplink grant from a master device to a slave device with which the master device communicates in the device-to-device communication;
a communication channel for the master device or the slave device to send feedback to the base station;
a communication channel for the device-to-device communication; and
an uplink subframe in the device-to-device communication for the master device to monitor signaling information sent by the base station.

7. A method as recited in claim 1, further comprising configuring the one special downlink subframe in the uplink and downlink splitting pattern as one of:
a shorted downlink subframe consisting of fourteen orthogonal frequency division multiplexing symbols and a last symbol being used in switching uplink and downlink of the device-to-device communication;
a shorted downlink subframe consisting of fourteen orthogonal frequency division multiplexing symbols in which fourth to thirteenth symbols are used in the device-to-device communication and remaining symbols are used in monitoring a packet dedicated control channel from a base station and switching the uplink and downlink of the device-to-device communication; and
a shorted downlink subframe only using a guard period and uplink pilot time slot parts of a special downlink subframe in cellular communication.

8. A method as recited in claim 1, wherein the configuring the uplink and downlink splitting pattern is performed in a dynamic manner, and the method further comprises one of:
predefining one uplink and one downlink subframe per subframe configuration period for sending an acknowledgement or a negative acknowledgement feedback, a channel quality indicator report, uplink scheduling, preamble, and the uplink and downlink splitting pattern;
predefining one downlink subframe per subframe configuration period to send uplink scheduling and the uplink and downlink splitting pattern for the next subframe configuration period and sending an acknowledgement or a negative acknowledgement feedback for the downlink transmission at the earliest possible uplink subframe; and
sending, at the earliest possible uplink and downlink subframe, an acknowledgement or a negative acknowledgement for scheduled downlink and uplink subframes and uplink scheduling.

9. A method as recited in any one of claims 1-8, further comprising performing the device-to-device communication based upon the uplink and downlink splitting pattern.

10. A method, comprising:
determining, mask information regarding which subframes in a frame for cellular communication may be used for device-to-device communication; and
configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

11. A method as recited in claim 10, further comprising signaling the uplink and downlink splitting pattern to a master device for the device-to-device communication.

12. A method as recited in claim 10, further comprising determining the start position of the subframe configuration period and values of X and N.

13. A method as recited in claim 10, wherein based upon the uplink and downlink splitting pattern, a guard period of a special subframe in the frame for the cellular communication may be used for one of:
a reserved or fixed downlink subframe for sending the uplink and downlink splitting pattern to be used for the device-to-device communication;
sending preamble to aid interference measurement;
a reserved or fixed downlink subframe for sending an uplink grant from a master device to a slave device with which the master device communicates in the device-to-device communication;
a communication channel for the master device or the slave device to send feedback to the base station;
a communication channel for the device-to-device communication; and
an uplink subframe in the device-to-device communication for the master device to monitor signaling information sent by the base station.

14. A method as recited in claim 10, further comprising configuring the one special downlink subframe in the uplink and downlink splitting pattern as one of:
a shorted downlink subframe consisting of fourteen orthogonal frequency division multiplexing symbols and a last symbol being used in switching uplink and downlink of the device-to-device communication;
a shorted downlink subframe consisting of fourteen orthogonal frequency division multiplexing symbols in which fourth to thirteenth symbols are used in the device-to-device communication and remaining symbols are used in monitoring a packet dedicated control channel from a base station and switching the uplink and downlink of the device-to-device communication; and
a shorted downlink subframe only using a guard period and uplink pilot time slot parts of a special downlink subframe in cellular communication.

15. A method as recited in any one of claims 10-14, wherein the configuring the uplink and downlink splitting pattern is performed in a dynamic manner, and the method further comprises one of:
predefining one uplink and one downlink subframe per subframe configuration period for sending an acknowledgement or a negative acknowledgement feedback, a channel quality indicator report, uplink scheduling, preamble, and the uplink and downlink splitting pattern;
predefining one downlink subframe per subframe configuration period to send uplink scheduling and the uplink and downlink splitting pattern for the next subframe configuration period and sending an acknowledgement or a negative acknowledgement feedback for the downlink transmission at the earliest possible uplink subframe; and
sending, at the earliest possible uplink and downlink subframe, an acknowledgement or a negative acknowledgement for scheduled downlink and uplink subframes and uplink scheduling.

16. An apparatus, comprising:
means for receiving, from a base station, mask information regarding which subframes in a frame for cellular communication may be used for device-to-device communication; and
means for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

17. An apparatus as recited in claim 16, further comprising means for reconfiguring the uplink and downlink splitting pattern subsequent to the configuring.

18. An apparatus as recited in claim 16, further comprising means for receiving, from the base station, position information regarding the start position of the subframe configuration period.

19. An apparatus as recited in claim 16, further comprising means for receiving, from the base station, value information regarding values for the integers X and N.

20. An apparatus as recited in claim 16, further comprising means for signaling the uplink and downlink splitting pattern to a slave device for the device-to-device communication.

21. An apparatus as recited in claim 16, wherein based upon the uplink and downlink splitting pattern, a guard period of a special subframe in the frame for the cellular communication may be used for one of:
a reserved or fixed downlink subframe for sending the uplink and downlink splitting pattern to be used for the device-to-device communication;
sending preamble to aid interference measurement;
a reserved or fixed downlink subframe for sending an uplink grant from a master device to a slave device with which the master device communicates in the device-to-device communication;
a communication channel for the master device or the slave device to send feedback to the base station;
a communication channel for the device-to-device communication; and
an uplink subframe in the device-to-device communication for the master device to monitor signaling information sent by the base station.

22. An apparatus as recited in claim 16, further comprising means for configuring the one special downlink subframe in the uplink and downlink splitting pattern as one of:
a shorted downlink subframe consisting of fourteen orthogonal frequency division multiplexing symbols and a last symbol being used in switching uplink and downlink of the device-to-device communication;
a shorted downlink subframe consisting of fourteen orthogonal frequency division multiplexing symbols in which fourth to thirteenth symbols are used in the device-to-device communication and remaining symbols are used in monitoring a packet dedicated control channel from a base station and switching the uplink and downlink of the device-to-device communication; and
a shorted downlink subframe only using a guard period and uplink pilot time slot parts of a special downlink subframe in cellular communication.

23. An apparatus as recited in claim 16, wherein the configuring the uplink and downlink splitting pattern is performed in a dynamic manner, and the apparatus further comprises one of:
means for predefining one uplink and one downlink subframe per subframe configuration period for sending an acknowledgement or a negative acknowledgement feedback, a channel quality indicator report, uplink scheduling, preamble, and the uplink and downlink splitting pattern;
means for predefining one downlink subframe per subframe configuration period to send uplink scheduling and the uplink and downlink splitting pattern for the next subframe configuration period and sending an acknowledgement or a negative acknowledgement feedback for the downlink transmission at the earliest possible uplink subframe; and
means for sending, at the earliest possible uplink and downlink subframe, an acknowledgement or a negative acknowledgement for scheduled downlink and uplink subframes and uplink scheduling.

24. An apparatus as recited in any one of claims 16-23, further comprising means for performing the device-to-device communication based upon the uplink and downlink splitting pattern.

25. An apparatus, comprising:
means for determining, mask information regarding which subframes in a frame for cellular communication may be used for device-to-device communication; and
means for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

26. An apparatus as recited in claim 25, further comprising means for signaling the uplink and downlink splitting pattern to a master device for the device-to-device communication.

27. An apparatus as recited in claim 25, further comprising means for determining the start position of the subframe configuration period and values of X and N.

28. An apparatus as recited in claim 25, wherein based upon the uplink and downlink splitting pattern, a guard period of a special subframe in the frame for the cellular communication may be used for one of:
a reserved or fixed downlink subframe for sending the uplink and downlink splitting pattern to be used for the device-to-device communication;
sending preamble to aid interference measurement;
a reserved or fixed downlink subframe for sending an uplink grant from a master device to a slave device with which the master device communicates in the device-to-device communication;
a communication channel for the master device or the slave device to send feedback to the base station;
a communication channel for the device-to-device communication; and
an uplink subframe in the device-to-device communication for the master device to monitor signaling information sent by the base station.

29. An apparatus as recited in claim 25, further comprising means for configuring the one special downlink subframe in the uplink and downlink splitting pattern as one of:
a shorted downlink subframe consisting of fourteen orthogonal frequency division multiplexing symbols and the last symbol being used in switching uplink and downlink of the device-to-device communication;
a shorted downlink subframe consisting of fourteen orthogonal frequency division multiplexing symbols in which the fourth to thirteenth symbols are used in the device-to-device communication and the remaining symbols are used in monitoring a packet dedicated control channel from a base station and switching the uplink and downlink of the device-to-device communication; and
a shorted downlink subframe only using a guard period and uplink pilot time slot parts of a special downlink subframe in cellular communication.

30. An apparatus as recited in any one of claims 25-29, wherein the means for configuring the uplink and downlink splitting pattern operates in a dynamic manner, and the apparatus further comprises one of:
means for predefining one uplink and one downlink subframe per subframe configuration period for sending an acknowledgement or a negative acknowledgement feedback, a channel quality indicator report, uplink scheduling, preamble, and the uplink and downlink splitting pattern;
means for predefining one downlink subframe per subframe configuration period to send uplink scheduling and the uplink and downlink splitting pattern for the next subframe configuration period and sending an acknowledgement or a negative acknowledgement feedback for the downlink transmission at the earliest possible uplink subframe; and
means for sending, at the earliest possible uplink and downlink subframe, an acknowledgement or a negative acknowledgement for scheduled downlink and uplink subframes and uplink scheduling.

31. An apparatus, comprising:
at least one processor, and
at least one memory including computer program code,
the at least one memory and the computer program code configured to, with the at least one processor, cause the apparatus to at least perform:
receiving, from a base station, mask information regarding which subframes in a frame for cellular communication may be used for device-to-device communication; and
configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

32. An apparatus, comprising:
at least one processor, and
at least one memory including compute program code,
the at least one memory and the computer program code configured to, with the at least one processor, cause the apparatus to at least perform:
determining, mask information regarding which subframes in a frame for cellular communication may be used for device-to-device communication; and
configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

33. A computer program product, comprising at least one computer readable storage medium having a computer readable program code portion stored thereon, the computer readable program code portion comprising:
program code instructions for receiving, from a base station, mask information regarding which subframes in a frame for cellular communication may be used for device-to-device communication; and
program code instructions for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

34. A computer program product, comprising at least one computer readable storage medium having a computer readable program code portion stored thereon, the computer readable program code portion comprising:
program code instructions for determining, mask information regarding which subframes in a frame for cellular communication may be used for device-to-device communication; and
program code instructions for configuring, based upon the mask information, an uplink and downlink splitting pattern for the device-to-device communication, which includes one special downlink subframe, X uplink subframes immediately following the special downlink subframe, and (N−1−X) downlink subframes immediately following the X uplink subframes, wherein integer N is a subframe configuration period, and integer X is the number of uplink subframes included in the subframe configuration period.

35. The apparatus as recited in claim 16, further comprising means for configuring values for the integers X and N to make the uplink and downlink splitting pattern compatible with one of long-term evolution time division duplexing configurations.

36. The apparatus as recited in claim 16, wherein the apparatus comprises a device-to-device communication enabled mobile station.

37. The apparatus as recited in claim 25, further comprising means for configuring values for the integers X and N to make the uplink and downlink splitting pattern compatible with one of long-term evolution time division duplexing configurations.

38. The apparatus as recited in claim 25, wherein the apparatus comprises a base station.

39. The apparatus as recited in claim 31, wherein the computer program code, when executed, further causes the apparatus to configure values for the integers X and N to make the uplink and downlink splitting pattern compatible with one of long-term evolution time division duplexing configurations.

40. The apparatus as recited in claim 31, wherein the apparatus comprises a device-to-device communication enabled mobile station.

41. The apparatus as recited in claim 32, wherein the computer program code, when executed, further causes the apparatus to configure values for the integers X and N to make the uplink and downlink splitting pattern compatible with one of long-term evolution time division duplexing configurations.

42. The apparatus as recited in claim 32, wherein the apparatus comprises a base station.
